(19) United States
(12) Patent Application Publication
(10) Pub. No.: US 2018/0184773 A1
(43) Pub. Date: Jul. 5, 2018

(54) CASE AND MOUNT FOR HANDHELD ELECTRONIC DEVICE

(71) Applicant: RokForm IP LLC, Irvine, CA (US)

(72) Inventor: Jeff S. Whitten, Irvine, CA (US)

(21) Appl. No.: 15/858,392

(22) Filed: Dec. 29, 2017

Related U.S. Application Data
(60) Provisional application No. 62/440,066, filed on Dec. 29, 2016.

(51) Int. Cl. A45C 11/00; B60R 11/02

(52) U.S. Cl. CPC A45C 11/00; B60R 11/0241; B60R 2011/0008; A45C 2011/002; A45C 2011/001; A45C 2011/003

(57) ABSTRACT

A protective case for a handheld electronic device can include an opening in the rear wall which receives an attachment member. In some configurations, the attachment member can comprise a metal element, which allows the case to be mounted to one of a plurality of magnetic mounts. The attachment member can be recessed from an outer surface of the rear wall to define a shoulder that can engage the magnetic mount to inhibit slippage of the case from the mount.

### REFERENCE TO RELATED APPLICATIONS

This application claims the benefit of U.S. Provisional Application No. 62/440,066, filed Dec. 29, 2016, entitled “CASE AND MOUNT FOR HANDHELD ELECTRONIC DEVICE.”

This application hereby incorporates by reference the above-identified provisional application in its entirety.

### BACKGROUND

### Field

The present disclosure relates generally to protective cases for handheld electronic devices.

### Description of Related Art

Handheld and/or portable electronic devices (e.g., digital media players, mobile phones, smartphones, tablet computers, handheld readers, and similar devices) are becoming important and common tools. These tools are commonly in use, both at home and on the go.

However, with this frequency and variety of use comes the problem of proper protection. Without proper protection, a device may become damaged due to being dropped or by falling from an unsecured position. This damage may be permanent and cause loss of data or information. Moreover, the replacement cost of a handheld electronic device can be high.

Current protective systems for handheld electronic devices can be thick or bulky. Thick or bulky protective systems can be unappealing to the eye and take away from the thin or low-profile nature of modern-day handheld electronics devices.

A need exists for a protective system for handheld electronic devices that is thin and has a low profile or at least provides the consumer with a useful choice.

### SUMMARY

In at least one embodiment, the present application relates to a protective system for a handheld electronic device that overcomes the shortcomings of the prior art noted above.

In some embodiments, a protective system for a handheld electronic device is disclosed. The protective system comprises a shell having a rear wall with an outer surface, and a plurality of wall surfaces arranged to enclose a plurality of peripheral edges of a handheld electronic device. The outer surface of the rear wall further defines an attachment region designed to receive an elastomeric member. The attachment region can include an opening or recess which receives the elastomeric member. The elastomeric member removably receives a thin metal plate. The thin metal plate allows the shell to be mounted to one of a plurality of magnetic mounts. The thin metal plate is recessed from the outer surface of the rear wall to define a shoulder that can engage the magnetic mount to inhibit slippage of the shell from or relative to the mount.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall further comprises an outer surface. The outer surface of the rear wall defines an attachment region comprising an opening or recess designed to receive an elastomeric member. The elastomeric member permanently or removably receives a thin metal plate. The thin metal plate is recessed from the outer surface of the rear wall to define a shoulder that can engage a magnetic mount to inhibit slippage of the shell from or relative to the mount.

In some embodiments, the shell further comprises at least one access opening that allows access to control features of the handheld electronic device.

In some embodiments, the magnetic mount is configured to be attachable to an automobile air conditioner (or heater) vent.

In some embodiments, the surface of the magnetic mount is textured to inhibit slippage of the shell from the mount, when in use.

In some embodiments, the magnetic mount has a lip that engages with the shoulder of the shell to inhibit slippage of the shell from the mount, when in use.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall further comprises an outer surface. The outer surface of the rear wall defines an attachment region comprising an opening or recess designed to receive an elastomeric disc. The elastomeric disc is configured to permanently or removably receive a thin metal disc. The thin metal disc is recessed from the outer surface of the rear wall to define a shoulder that can engage a magnetic mount to inhibit slippage of the shell from the mount.

In some embodiments, the shell further comprises at least one access opening that allows access to control features of the handheld electronic device.

In some embodiments, the magnetic mount has a textured surface and is configured to be attachable to an automobile air conditioner (or heater) vent.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall further comprises an outer surface. The outer surface of the rear wall defines an attachment region comprising an opening or recess designed to receive a cushioning material. The cushioning material permanently or removably receives a thin metal disc. The thin metal disc is recessed from the outer surface of the rear wall to define a shoulder that can engage a magnetic mount to inhibit slippage of the shell from the mount.

In some embodiments, the cushioning material is an elastomeric disc.

In some embodiments, the shell further comprises at least one access opening that allows access to control features of the handheld electronic device.

In some embodiments, the magnetic mount has a textured surface and is configured to be attachable to an automobile air conditioner (or heater) vent.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, a protective system for a handheld electronic device is disclosed. The protective system comprises a shell comprised of a rear wall and a plurality of wall surfaces arranged to enclose a plurality of peripheral edges of a handheld electronic device. The rear wall further defines an attachment region designed to permanently or removably receive an insertable member. The attachment region can include an opening or recess which permanently or removably receives the insertable member. Preferably, a plurality of insertable members is available.

In some embodiments, the insertable member is comprised of an elastomeric material or other plastic material. The insertable member has an inner surface and an outer surface. When the insertable member is received in or by the attachment region, the inner surface of the insertable member faces in the same direction as an inner surface of the rear wall of the shell, and the outer surface of the insertable member faces in the same direction as an outer surface of the rear wall of the shell. Preferably, the insertable member has an indentation on its outer surface. The indentation can have various shapes. However, preferably, the indentation is circular in shape or generally square or rectangular in shape.

In some embodiments, the indentation on the outer surface of the insertable member removably or permanently receives a thin plate. The thin plate can include a logo or other message. In some embodiments, the thin plate is a thin metal plate and, when the insertable member is received in or by the attachment region of the shell, the thin metal plate allows the shell to be mounted to one of a plurality of magnetic mounts. Preferably, the thin metal plate is recessed from the outer surface of the insertable member to define a shoulder that can engage a magnetic mount to inhibit slippage of the shell from or relative to the mount. The shoulder defines a perimeter which takes on the shape of the indentation. In embodiments where the indentation of the insertable member is generally square or rectangular in shape, the generally square or rectangular shape of the perimeter defined by the shoulder can inhibit rotation of the shell relative to the mount.

In some embodiments, the insertable member has a perimeter which defines a first ridge, a second ridge, and a groove disposed between the first and second ridges. In some embodiments, the diameters of the first and second ridges are the same. In other embodiments, the diameter of the first ridge can be less than or greater than the diameter of the second ridge.

In a preferred embodiment, the attachment region comprises an opening configured to permanently or removably receive an insertable member. The shape of the insertable member corresponds to the shape of the opening. A perimeter of the opening is configured to couple with the insertable member. When the insertable member is received in or by the opening of the attachment region, the first ridge of the insertable member engages a portion of the perimeter of the opening defined by the outer surface of the rear wall and the second ridge of the insertable member engages a portion of the perimeter of the opening defined by the inner surface of the rear wall. In this way, a portion of the perimeter of the opening is received within the groove disposed between the first and second ridges.

In some embodiments, the diameter of the first ridge is less than the diameter of the second ridge, so as to facilitate insertion of the insertable member into the opening of the attachment region from the inner surface of the rear wall of the shell. In some embodiments, the diameter of the second ridge is less than the diameter of the first ridge, so as to facilitate insertion of the insertable member into the opening of the attachment region from the outer surface of the rear wall of the shell.

Preferably, the perimeter of opening is defined by an inner shoulder on the inner surface of the rear wall and an outer shoulder on the outer surface of the rear wall. When the insertable member is received in or by the opening of the attachment region, the first ridge of the insertable member engages the outer shoulder and the second ridge of the insertable member engages the inner shoulder. In this way, the inner surface of the insertable member can be flush with the inner surface of the rear wall of the shell, and the outer surface of the insertable member can be flush with the outer surface of the rear wall of the shell. However, in some embodiments, the outer surface of the insertable member can extend outwardly of at least a portion of the outer surface of the rear wall of the shell.

In some embodiments, the outer surface of the insertable member is textured and extends outwardly of at least a portion of the outer surface of the rear wall of the shell. The textured outer surface of the insertable member can enhance frictional engagement of the shell with a surface on which the shell is placed.

In another embodiment, the insertable member has perimeter comprising a lip or shoulder. The attachment region of the shell comprises an opening configured to permanently or removably receive the insertable member. The shape of the insertable member corresponds to the shape of the opening. The perimeter of the opening is configured to couple with the insertable member. The perimeter of the opening is defined by a lip or shoulder on an inner surface of the rear wall of the shell. When the insertable member is received in or by the opening of the attachment region, the perimeter of the insertable member engages the lip or shoulder of the opening. Preferably, a lip or shoulder of the insertable member engages the corresponding lip or shoulder of the opening. In this way, the inner surface of the insertable member can be flush with the inner surface of the rear wall of the shell. In some embodiments, the outer surface of the insertable member can also be flush with the outer surface of the rear wall of the shell. However, in some embodiments, the outer surface of the insertable member can extend outwardly of at least a portion of the outer surface of the rear wall of the shell. The insertable member can be secured to the attachment region of the shell by a friction fit engagement or by other means (adhesive, etc.).

In some embodiments, the indentation on the outer surface of the insertable member removably or permanently receives a thin non-metal plate. The thin non-metal plate can comprise a plastic material. However, the thin non-metal plate can also comprise other materials. The thin non-metal plate can include a logo or other message.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall has an inner surface and an outer surface and defines an attachment region comprising an opening designed to receive an insertable member. A perimeter of the opening is defined by an inner shoulder on the inner surface of the rear wall and an outer shoulder on the outer surface of the rear wall. The insertable member has an inner surface and an outer surface, and has a perimeter which defines a first ridge, a second ridge, and a groove disposed between the first and second ridges. The outer surface of the insertable member comprises an indentation that receives a thin metal plate. When the insertable member is received in the opening of the attachment region, the thin metal plate allows the shell to be mounted to one of a plurality of magnetic mounts. The thin metal plate is recessed from the outer surface of the insertable member to define a shoulder that can engage the magnetic mount to inhibit slippage of the shell from or relative to the mount. When the insertable member is received in the opening of the attachment region, the first ridge of the insertable member engages the outer shoulder and the second ridge of the insertable member engages the inner shoulder, such that a portion of the perimeter of the opening is received within the groove disposed between the first and second ridges to secure the insertable member to the shell.

In some embodiments, the shell further comprises at least one access opening that allows access to control features of the handheld electronic device.

In some embodiments, the magnetic mount is configured to be attachable to an automobile air conditioner (or heater) vent.

In some embodiments, the surface of the magnetic mount is textured to inhibit slippage of the shell from the mount, when in use.

In some embodiments, the magnetic mount is configured to have a lip that engages with the shoulder of the insertable member to inhibit slippage of the shell from the mount, when in use.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, the first ridge of the insertable member has a first diameter and the second ridge of the insertable member has a second diameter, the first diameter being less than the second diameter

In some embodiments, the insertable member is received in the opening of the attachment region from the inner surface of the rear wall of the shell.

In some embodiments, the first ridge of the insertable member has a first diameter and the second ridge of the insertable member has a second diameter, the first diameter being greater than the second diameter.

In some embodiments, the insertable member is received in the opening of the attachment region from in the outer surface of the rear wall of the shell.

In some embodiments, the inner surface of the insertable member is flush with the inner surface of the rear wall of the shell.

In some embodiments, the outer surface of the insertable member is flush with the outer surface of the rear wall of the shell.

In some embodiments, the outer surface of the insertable member is disposed outwardly of at least a portion of the outer surface of the rear wall of the shell.

In some embodiments, the outer surface of the insertable member is textured.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall defines an attachment region comprising an opening designed to receive an insertable member. An outer surface of the insertable member comprises an indentation that receives a thin plate.

In some embodiments, the opening has a perimeter, the perimeter of the opening defined by an inner shoulder on an inner surface of the rear wall and an outer shoulder on an outer surface of the rear wall.

In some embodiments, the insertable member has a perimeter which defines a first ridge, a second ridge, and a groove disposed between the first and second ridges.

In some embodiments, when the insertable member is received in the opening of the attachment region, the first ridge of the insertable member engages the outer shoulder and the second ridge of the insertable member engages the inner shoulder, such that a portion of the perimeter of the opening is received within the groove disposed between the first and second ridges to secure the insertable member to the shell.

In some embodiments, the thin plate is a thin metal plate.

In some embodiments, when the insertable member is received in the opening of the attachment region, the thin metal plate allows the shell to be mounted to one of a plurality of magnetic mounts.

In some embodiments, the thin metal plate is recessed from the outer surface of the insertable member to define a shoulder that can engage the magnetic mount to inhibit slippage of the shell from or relative to the mount.

In some embodiments, the shell further comprises at least one access opening that allows access to control features of the handheld electronic device.

In some embodiments, the magnetic mount is configured to be attachable to an automobile air conditioner (or heater) vent.

In some embodiments, the surface of the magnetic mount is textured to inhibit slippage of the shell from the mount, when in use.

In some embodiments, the magnetic mount is configured to have a lip that engages with the shoulder of the insertable member to inhibit slippage of the shell from the mount, when in use.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, the first ridge of the insertable member has a first diameter and the second ridge of the insertable member has a second diameter, the first diameter being less than the second diameter

In some embodiments, the insertable member is received in the opening of the attachment region from the inner surface of the rear wall of the shell.

In some embodiments, the first ridge of the insertable member has a first diameter and the second ridge of the insertable member has a second diameter, the first diameter being greater than the second diameter.

In some embodiments, the insertable member is received in the opening of the attachment region from in the outer surface of the rear wall of the shell.

In some embodiments, an inner surface of the insertable member is flush with the inner surface of the rear wall of the shell.

In some embodiments, the outer surface of the insertable member is flush with the outer surface of the rear wall of the shell.

In some embodiments, the outer surface of the insertable member is disposed outwardly of at least a portion of the outer surface of the rear wall of the shell.

In some embodiments, the outer surface of the insertable member is textured.

In some embodiments, a protective system for a handheld electronic device is disclosed. The protective system comprises a shell having a rear wall and a side wall extending from the rear wall, wherein, in use, the side wall encloses a plurality of peripheral edges of an associated handheld electronic device. The rear wall defines an attachment region comprising an opening designed to receive an insertable member. An outer surface of the insertable member comprises an indentation that receives a thin plate.

In some embodiments, the opening has a perimeter, the perimeter of the opening defined by a lip or shoulder on an inner surface of the rear wall of the shell, the lip or shoulder formed by the disposition of a smaller opening within a larger opening.

In some embodiments, the insertable member has a perimeter comprising a lip or shoulder.

In some embodiments, when the insertable member is received in the opening of the attachment region, the lip or shoulder of the insertable member engages the corresponding lip or shoulder of the opening.

In some embodiments, the thin plate is a thin metal plate.

In some embodiments, when the insertable member is received in the opening of the attachment region, the thin metal plate allows the shell to be mounted to one of a plurality of magnetic mounts.

In some embodiments, the thin metal plate is recessed from the outer surface of the insertable member to define a shoulder that can engage the magnetic mount to inhibit slippage of the shell from or relative to the mount.

In some embodiments, the shell further comprises at least one access opening that allows access to control features of the handheld electronic device.

In some embodiments, the magnetic mount is configured to be attachable to an automobile air conditioner (or heater) vent.

In some embodiments, the surface of the magnetic mount is textured to inhibit slippage of the shell from the mount, when in use.

In some embodiments, the magnetic mount is configured to have a lip that engages with the shoulder of the insertable member to inhibit slippage of the shell from the mount, when in use.

In some embodiments, the magnetic mount comprises an adhesive layer that, in use, attaches to a mounting surface via adhesion.

In some embodiments, the magnetic mount comprises a suction cup that, in use, attaches to a mounting surface via suction.

In some embodiments, the insertable member is received in the opening of the attachment region from the inner surface of the rear wall of the shell.

In some embodiments, an inner surface of the insertable member is flush with the inner surface of the rear wall of the shell.

In some embodiments, the outer surface of the insertable member is flush with an outer surface of the rear wall of the shell.

In some embodiments, the outer surface of the insertable member is disposed outwardly of at least a portion of an outer surface of the rear wall of the shell.

In some embodiments, the outer surface of the insertable member is textured.

### BRIEF DESCRIPTION OF THE DRAWINGS

These and other features, aspects, and advantages of the present disclosure will now be described in connection with preferred embodiments, in reference to the accompanying drawings. The illustrated embodiments, however, are merely examples and are not intended to limit the disclosure.

FIG. 1 is a perspective view of the exterior rear surface of a shell of the protective system assembled onto a handheld electronic device, in particular, a smartphone.

FIG. 2 is a second perspective view of the exterior rear surface of a shell of the protective system.

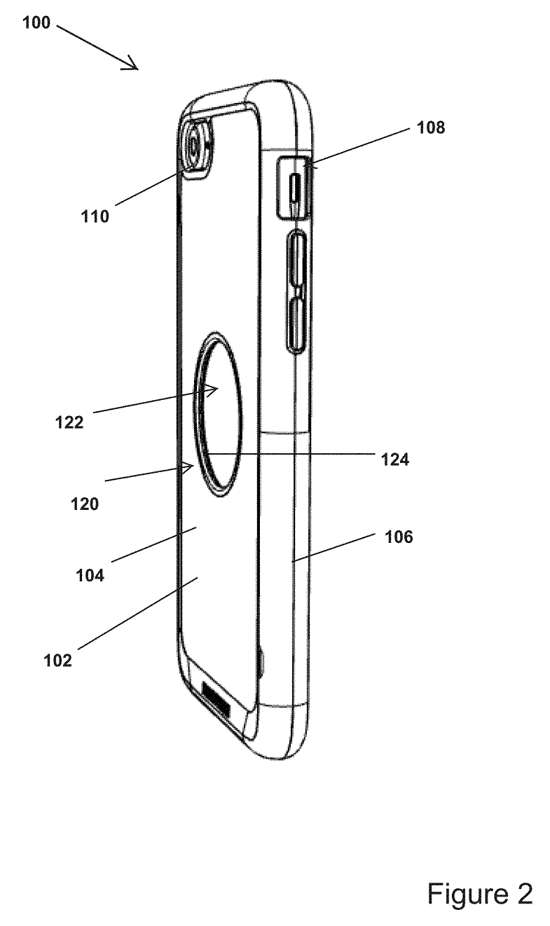

FIG. 3 is a view of the exterior rear surface of a shell of the protective system.

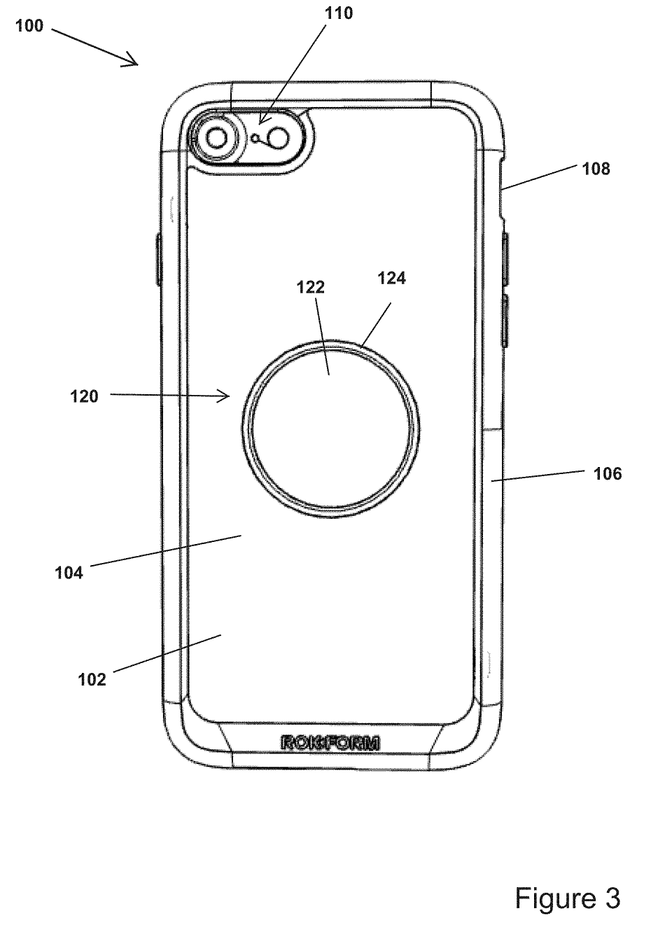

FIG. 4 is a third perspective view of the exterior rear surface of a shell of the protective system.

FIG. 5 is a perspective view of a magnetic mount.

FIG. 6 is a view of the interior rear surface of the shell of another embodiment of the protective system.

FIG. 7 is a view of the exterior rear surface of the shell of the embodiment of the protective system shown in FIG. 6.

FIG. 8 is a perspective view of the interior rear surface of the shell of the embodiment of the protective system shown in FIG. 6.

FIG. 9 is a perspective view of the exterior rear surface of the shell of the embodiment of the protective system shown in FIG. 6.

FIG. 10 is a second perspective view of the interior rear surface of the shell of the embodiment of the protective system shown in FIG. 6.

FIG. 11 is a second perspective view of the exterior rear surface of the shell of the embodiment of the protective system shown in FIG. 6.

FIG. 12 is a third perspective view of the interior rear surface of the shell of the embodiment of the protective system shown in FIG. 6.

FIG. 13 is a third perspective view of the exterior rear surface of the shell of the embodiment of the protective system shown in FIG. 6.

FIG. 14 is a view of the attachment region of the shell of the embodiment of the protective system shown in FIG. 6, shown from the interior rear surface of the shell.

FIG. 15 is a view of the attachment region of the shell of the embodiment of the protective system shown in FIG. 6, shown from the exterior rear surface of the shell.

FIG. 16 is a perspective view of the insertable member of the embodiment of the protective system shown in FIG. 6.

FIG. 17 is another perspective view of the insertable member of the embodiment of the protective system shown in FIG. 6.

FIG. 18 is a perspective view of the attachment region of the shell of the embodiment of the protective system shown in FIG. 6, shown from the interior rear surface of the shell.

FIG. 19 is a perspective view of the attachment region of the shell of the embodiment of the protective system shown in FIG. 6, shown from the exterior rear surface of the shell.

FIG. 20 is a perspective view of the interior rear surface of the shell of the embodiment of the protective system shown in FIG. 6, shown with the insertable member received in the attachment region of the shell.

FIG. 21 is a perspective view of the exterior rear surface of the shell of the embodiment of the protective system shown in FIG. 6, shown with the insertable member received in the attachment region of the shell.

FIG. 22 is second perspective view of the exterior rear surface of the shell of the embodiment of the protective system shown in FIG. 6, shown with the insertable member received in the attachment region of the shell.

FIG. 23 shows the insertable member of the embodiment of the protective system shown in FIG. 6, together with a magnetic mount configured to engage with the insertable member.

### DETAILED DESCRIPTION

The following detailed description is directed to certain specific embodiments of the protection system. However, the protection system may be embodied in a multitude of different ways as defined and covered by the claims.

Embodiments of the disclosure can provide the features of a protection system for a portable or handheld electronic device (hereinafter “handheld electronic device”). Some embodiments of the protection system desirably may incorporate an attachment region for attaching a removable mount or mounting member preferably able to support the handheld electronic device within the protection system and affixed to a variety of surfaces.

A preferred embodiment of the protection system comprises a shell for securing and protecting a handheld electronic device. In a preferred embodiment, the shell comprises a rear wall with an outer surface. The outer surface of the rear wall preferably defines an attachment region designed to receive an attachment member, which may be or comprise an elastomeric member. Preferably, the attachment region includes an opening or recess which receives the elastomeric member. Preferably, the elastomeric member permanently or removably receives a thin metal plate. The thin metal plate preferably allows the shell to be mounted to one of a plurality of magnetic mounts. The thin metal plate is preferably no more than about 0.5-1.0 millimeters thick or any sub-range or value within this range. Preferably, the thin metal plate is recessed from the outer surface of the rear wall such that one or both of the rear wall or elastomeric member defines a shoulder that can engage the magnetic mount to inhibit slippage of the shell from or relative to the mount.

The shell preferably is formed using a material that is generally rigid and lightweight, such as but not limited to an injection molded polycarbonate, an extruded polycarbonate, or other suitable plastic material(s). Preferably, the shell comprises rigid side walls that surround an entirety or portions of the peripheral edges of the device. The side walls preferably are arranged to protect the device by absorbing incidental shock forces and/or inhibiting or preventing direct contact between the device and another object. The side walls also desirably contain various openings to allow access to the control buttons, inputs, and outputs of the handheld electronic device. The rear surface of the shell is preferably further designed with various openings to allow additional access to features of the handheld electronic device that may be located on the rear of the device (such as a camera lens) or to reduce the weight of the shell. In some configurations, the shell is a multi-component integrated structure, which can include multiple types of materials and can be constructed using over-molding or co-molding techniques, for example.

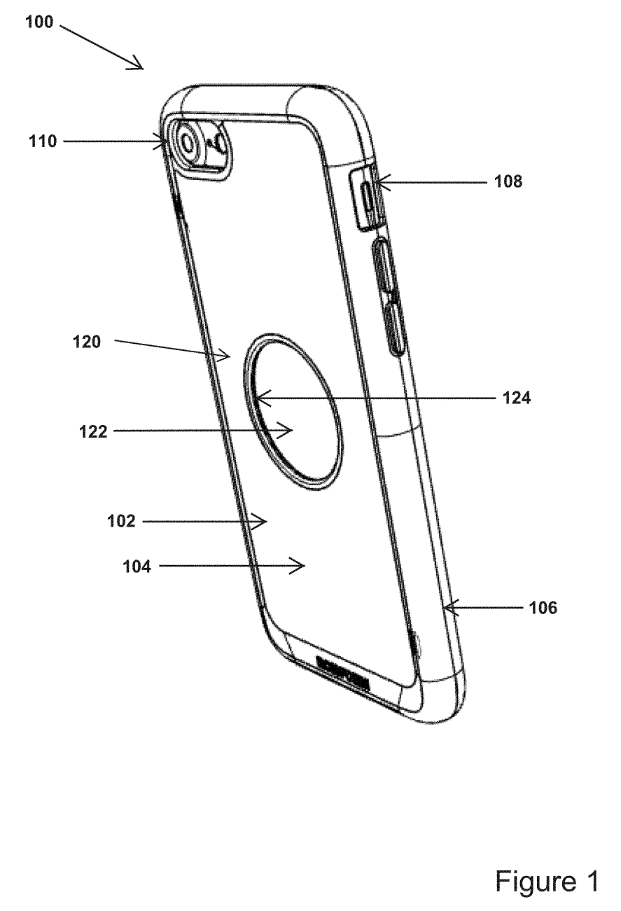

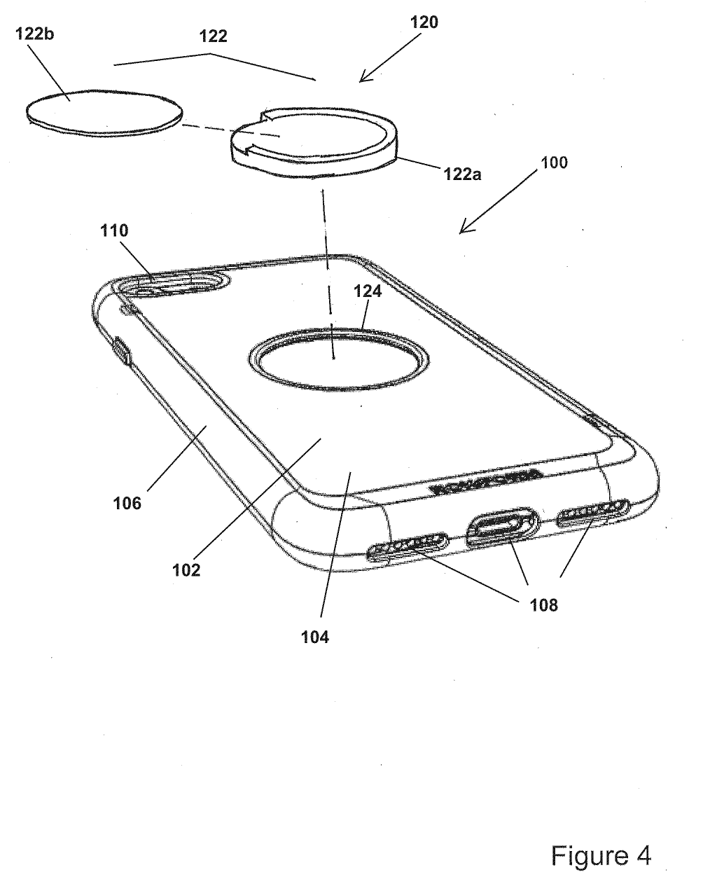

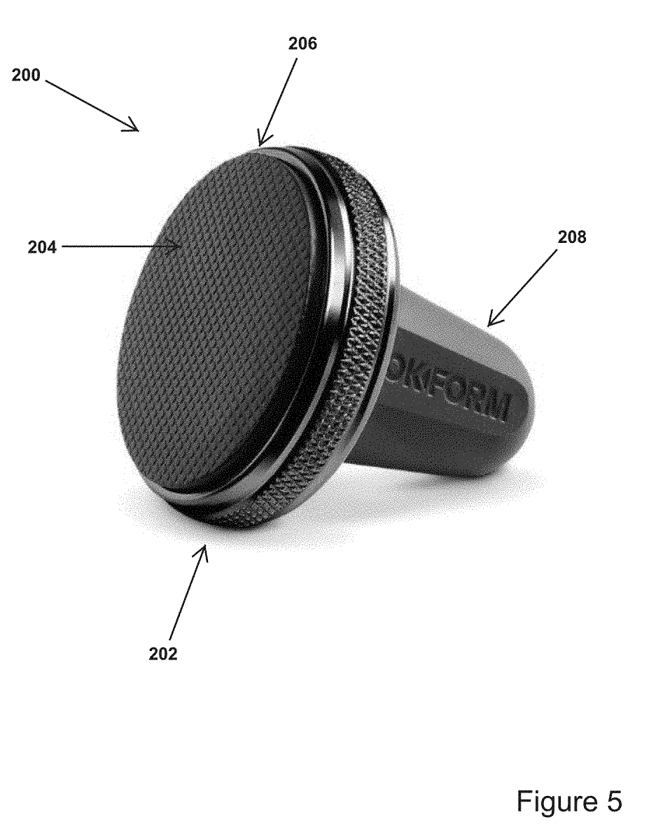

FIG. 1 depicts a preferred embodiment having certain features, aspects and advantages of the present disclosure. In FIG. 1, the protection system 100 may include more, fewer or different components than those shown. The protection system 100 includes a body or shell that, in the illustrated embodiment, comprises a rear wall 102 with an outer surface 104. The outer surface 104 of the rear wall 102 defines an attachment region 120 that receives or otherwise supports an attachment member 122, which preferably comprises an elastomeric or deformable element 122a and a metal element 122b (FIG. 4). As illustrated, the rear wall 102 within the attachment region 120 includes an opening or recess which receives the attachment member 122. However, other embodiments are possible. In the illustrated arrangement of the attachment member 122, the elastomeric member 122a supports a thin metal plate 122b, such as within a slot defined by the elastomeric member 122a. In some configurations, the thin metal plate 122b is removable to allow removal or replacement. In some configurations, the metal plate 122b can have a standard or custom design, such as a laser etched standard or custom design. Preferably, a plurality of thin metal plates 122b is available. In other configurations, the thin metal plate 122b can be permanently secured to the elastomeric member 122a. The thin metal plate 122b allows the shell to be mounted to one of a plurality of magnetic mounts (e.g., the mount 200 of FIG. 5). The elastomeric (or otherwise deformable) member 122a can allow for or facilitate assembly of the attachment member 122 to the shell of the protection system 100. In the illustrated embodiment, the attachment member 122 is recessed inwardly from the outer surface 104 of the rear wall 102 to define a lip or shoulder 124 that can engage the magnetic mount to inhibit slippage of the shell from or relative to the mount.

With reference still to FIG. 1, the body or shell of the protection system 100 further comprises a plurality of wall surfaces or side walls 106 arranged to enclose a plurality of peripheral edges of a handheld electronic device, such as a smartphone. As illustrated, the side walls 106 contain one or more openings 108 to allow access to the control buttons, inputs, and outputs of the handheld electronic device. As illustrated, the rear wall 102 of the shell is further designed with one or more openings 110 to allow additional access to features of the handheld electronic device that may be located on the rear of the device (such as a camera lens) or to reduce the weight of the shell. The shell may also include soft buttons or other deformable regions that permit operation of underlying control buttons of the handheld electronic device.

FIG. 5 depicts an embodiment of a magnetic mount 200. The mount 200 comprises an attachment region 202 which comprises a textured surface 204. The textured surface 204 helps to inhibit slippage of the shell from or relative to the mount 200, when in use. The attachment region 202 is preferably configured to have a lip or shoulder 206 that can engage with the lip or shoulder 124 of the shell to define cooperating abutment surfaces to further inhibit slippage of the shell from or relative to the mount 200. The mount 200 has a body region 208, which is configured to be attachable to another object. In the illustrated arrangement, the body region 208 is configured for attachment to an automobile air conditioner (or heater) vent. However, other types of body regions 208 can be provided depending on the desired use of the mount 200. For example, clip, adhesive or suction mount type body regions 208 can be provided.

In another preferred embodiment, a protective system for a handheld electronic device is disclosed. The protective system comprises a shell comprised of a rear wall and a plurality of wall surfaces arranged to enclose a plurality of peripheral edges of a handheld electronic device. The rear wall further defines an attachment region designed to permanently or removably receive an insertable member. Preferably, the attachment region includes an opening or recess which permanently or removably receives the insertable member. In some configurations, a plurality of insertable members is available. Preferably, the insertable member permanently or removably receives a thin metal plate. The thin metal plate preferably is no more than about 0.5-1.0 millimeters thick or any sub-range or value within that range. Preferably, the thin metal plate is recessed from the outer surface of the insertable member or an outer surface of the rear wall of the shell to define a shoulder that can engage a magnetic mount to inhibit slippage of the shell from or relative to the mount.

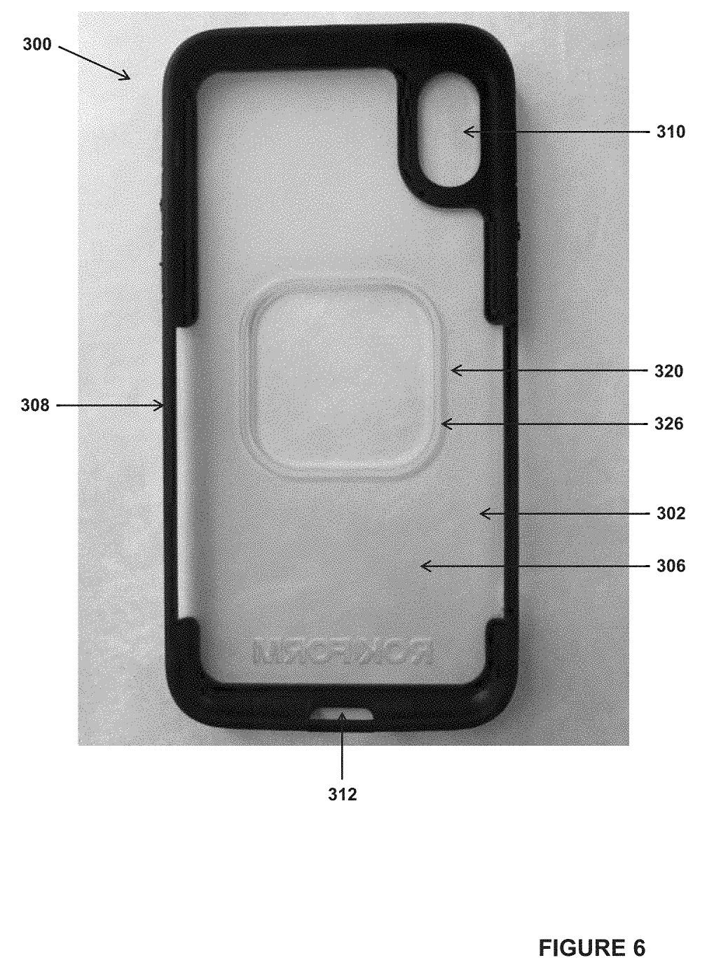

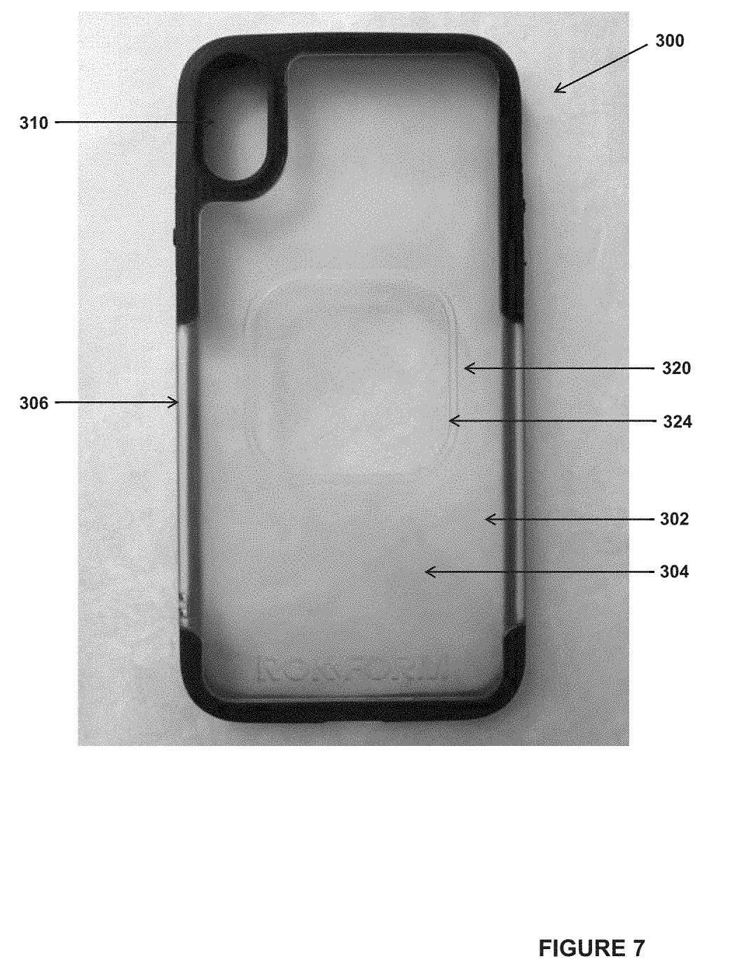

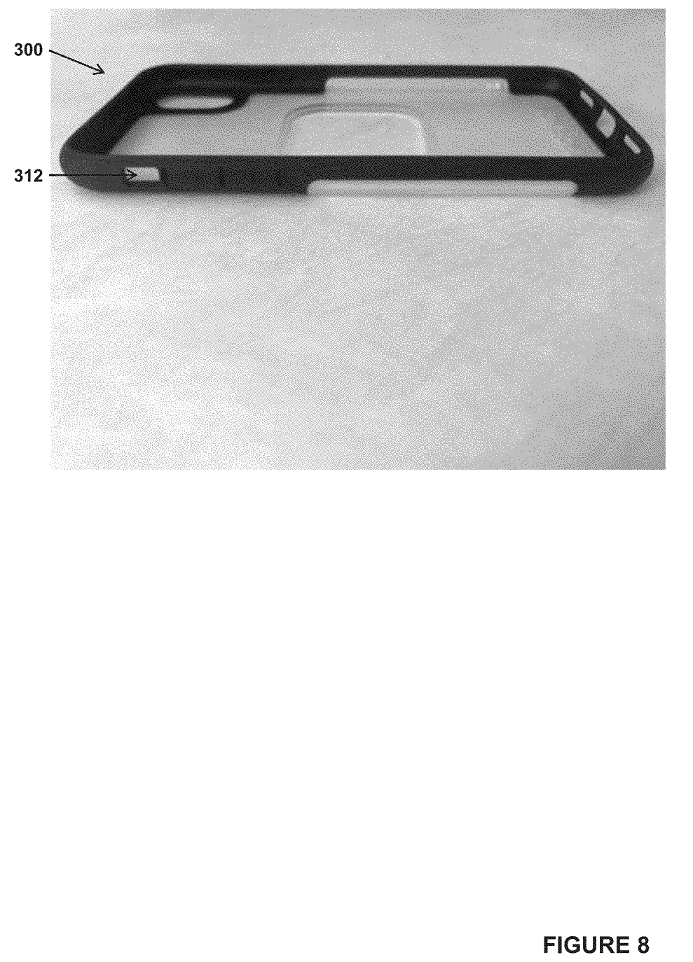

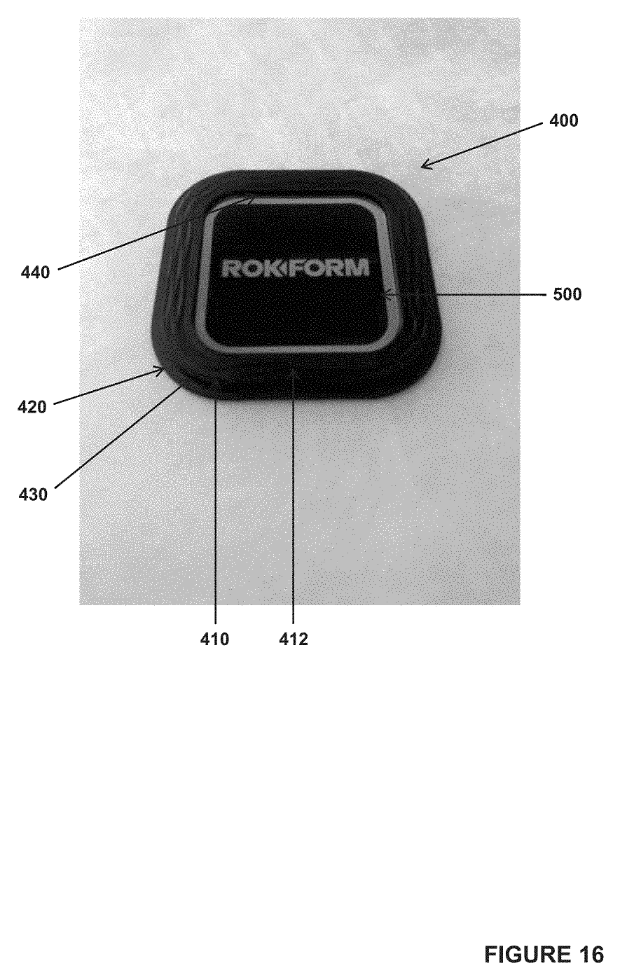

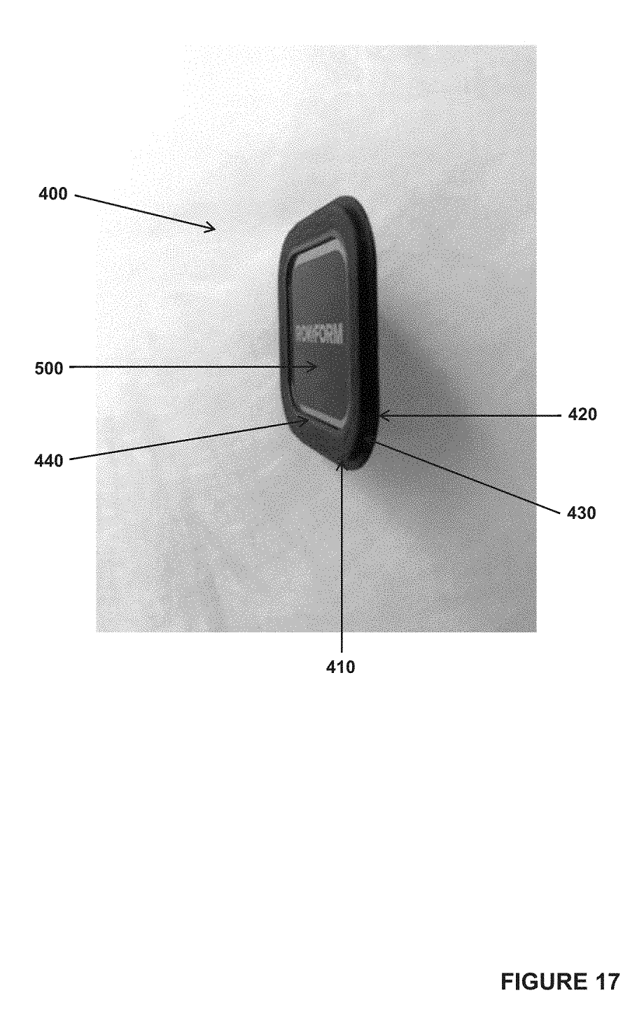

FIGS. 6 and 7 depict a preferred embodiment having certain features, aspects and advantages of the present disclosure. In FIGS. 6 and 7, the protection system 300 may include more, fewer or different components than those shown. The protection system 300 includes a body or shell that, in the illustrated embodiment, comprises a rear wall 302 with an outer surface 304 (FIG. 7) and inner surface 306 (FIG. 8). The rear wall 302 defines an attachment region 320. As illustrated, the attachment region 320 includes an opening designed to receive an insertable member 400, an embodiment of which is shown in FIGS. 16, 17, and 23. However, other embodiments are possible. For example, preferably, at least an insertable member 400 is provided that incorporates a metal or magnetic element such that the corresponding system 300 can be used with a magnetic mount. In some arrangements, the system 300 also includes an insertable member 400 that does not incorporate a metal or magnetic element, which can allow or facilitate the use of wireless charging devices for the handheld electronic device held within the system 300. In some configurations, a kit includes the shell, a metal/magnetic insertable member 400 and a non-metal/non-magnetic insertable member.

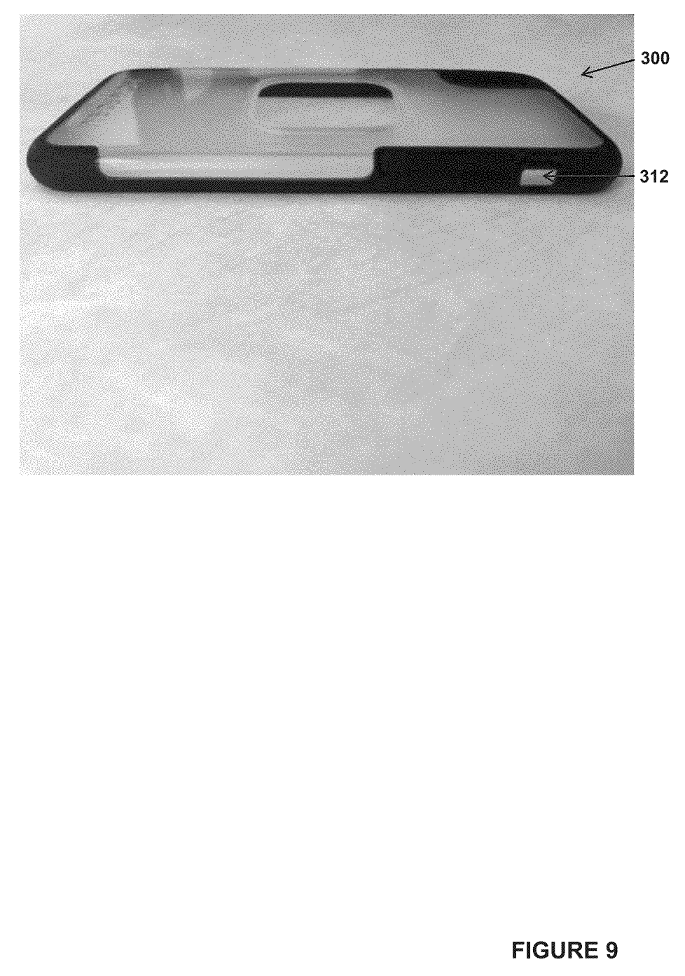

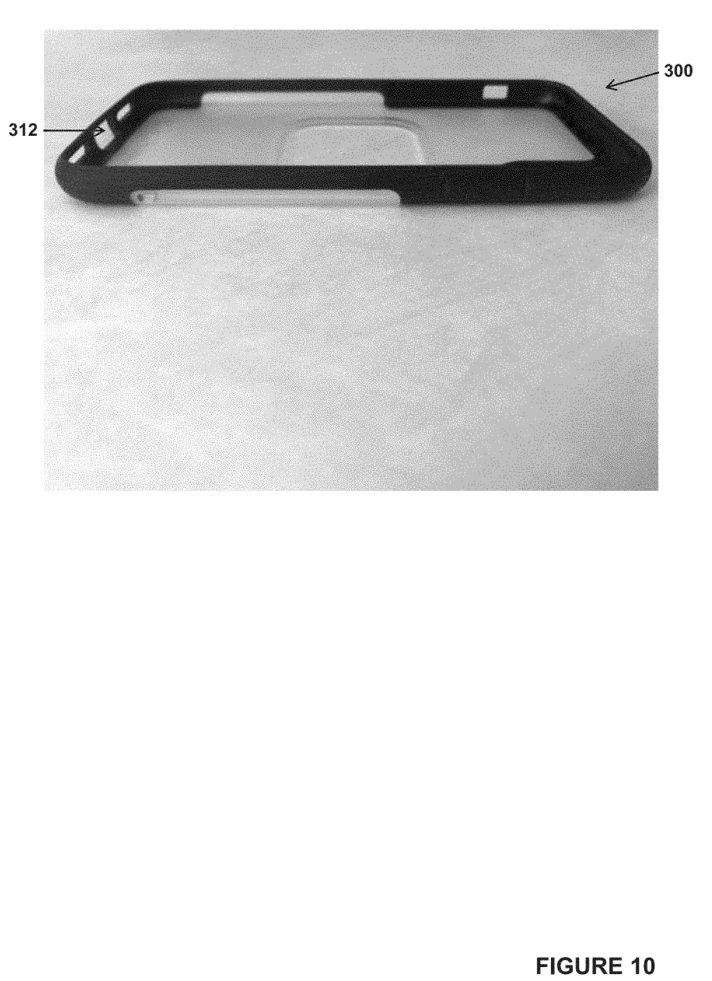

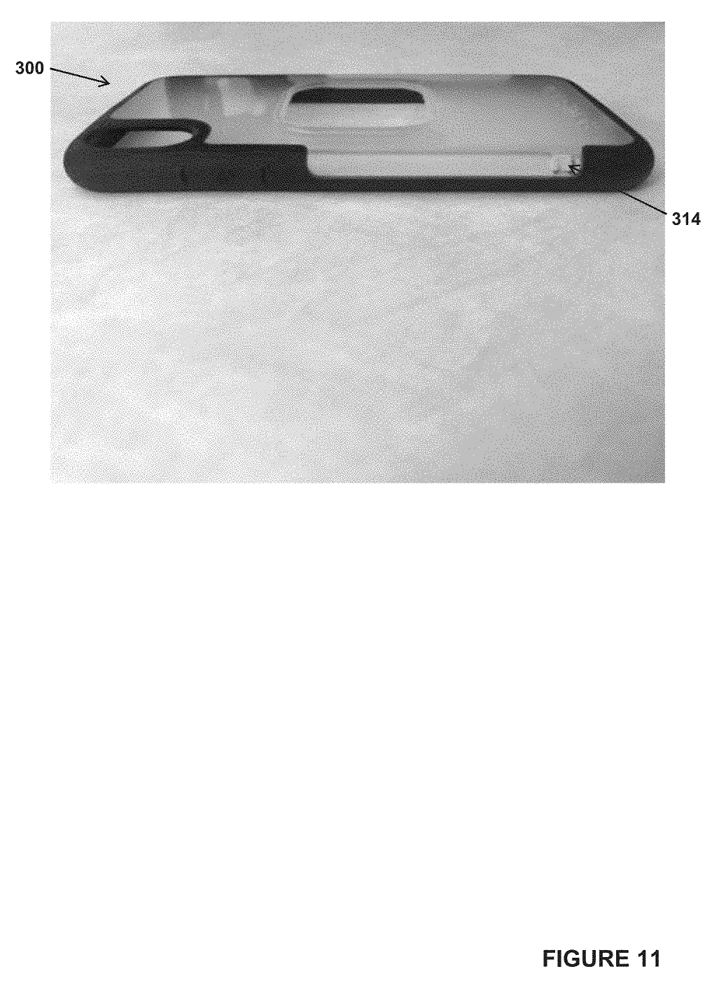

With reference still to FIGS. 6 and 7, the body or shell of the protection system 300 further comprises a plurality of wall surfaces or side walls 308 arranged to enclose a plurality of peripheral edges of a handheld electronic device. As illustrated in FIGS. 6 and 8-10, the side walls 308 contain one or more openings 312 to allow access to the control buttons, inputs, and outputs of the handheld electronic device. As illustrated in FIGS. 6 and 7, the rear wall 302 of the shell is further designed with one or more openings 310 to allow additional access to features of the handheld electronic device that may be located on the rear of the device (such as a camera lens) or to reduce the weight of the shell. As shown in FIG. 11, the side walls 308 can include holes or openings 314 specifically designed to couple with a lanyard or other accessory. The shell may also include soft buttons or other deformable regions that permit operation of underlying control buttons of the handheld electronic device.

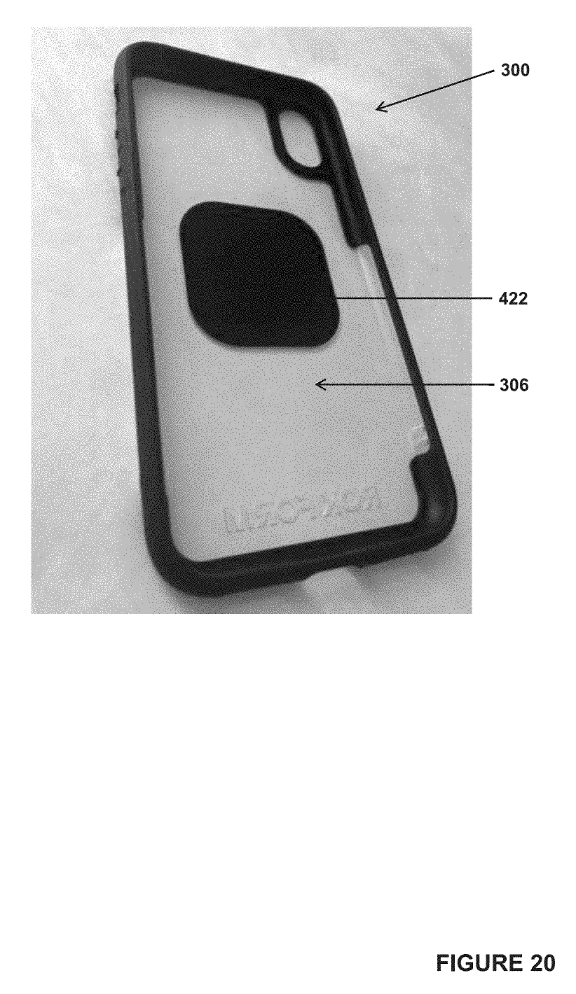

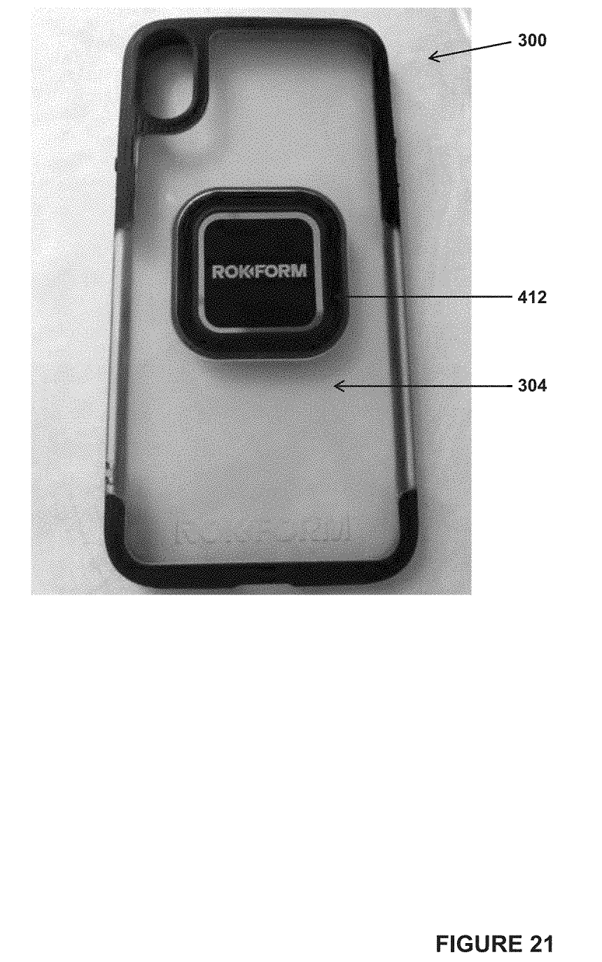

In some embodiments, the insertable member 400 is comprised of an elastomeric material or other plastic material. The insertable member 400 has an outer surface 412 (FIG. 21) and an inner surface 422 (FIG. 20). When the insertable member 400 is received in or by the attachment region 320, the inner surface 422 of the insertable member 400 faces in the same direction as the inner surface 306 of the rear wall 302 of the shell, and the outer surface 412 of the insertable member 400 faces in the same direction as the outer surface 304 of the rear wall 302 of the shell. Preferably, the insertable member 400 has an indentation on its outer surface 412. The indentation can have various shapes. However, preferably, the indentation is circular in shape or generally square or rectangular in shape. In the embodiment of the insertable member 400 shown in FIGS. 16, 17, and 23, the indentation is generally square in shape.

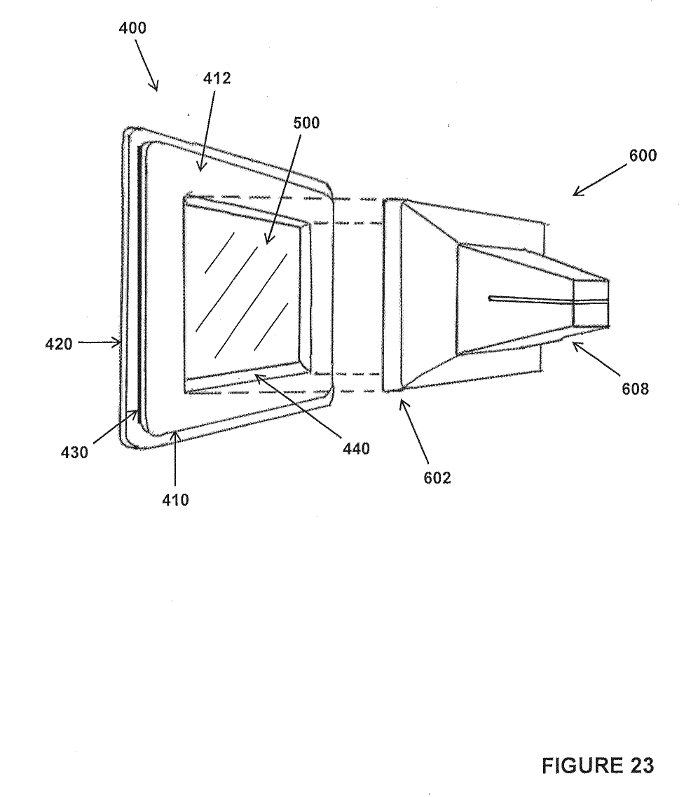

In some embodiments, the indentation on the outer surface 412 of the insertable member 400 removably or permanently receives a thin plate. In some embodiments, the thin plate is a thin metal plate 500 and, when the insertable member 400 is received in or by the attachment region 320 of the shell, the thin metal plate 500 allows the shell to be mounted to one of a plurality of magnetic mounts (e.g., the mount 200 of FIG. 5 or the mount 600 of FIG. 23). Preferably, the thin metal plate 500 is recessed from the outer surface 412 of the insertable member 400 to define a shoulder 440 that can engage a magnetic mount to inhibit slippage of the shell from or relative to the mount. The shoulder 440 defines a perimeter which takes on the shape of the indentation. In embodiments where the indentation of the insertable member 400 is generally square or rectangular in shape, the generally square or rectangular shape of the perimeter defined by the shoulder 440 can inhibit rotation of the shell relative to a mount having a corresponding or complementary non-circular shape.

In the embodiment shown in FIGS. 16, 17, and 23, the insertable member 400 has a perimeter which defines a first ridge 410, a second ridge 420, and a groove 430 disposed between the first and second ridges 410, 420. In some embodiments, the shape and/or height and width dimensions (or diameter in a circular embodiment) of the first and second ridges 410, 420 are the same. In other embodiments, the height and/or width dimensions (or diameter in a circular embodiment) of the first ridge 410 can be less than or greater than the diameter of the second ridge 420. As shown in FIGS. 16, 17, and 23, the height and width dimensions of the first ridge 410 are less than the height and width dimensions of the second ridge 420.

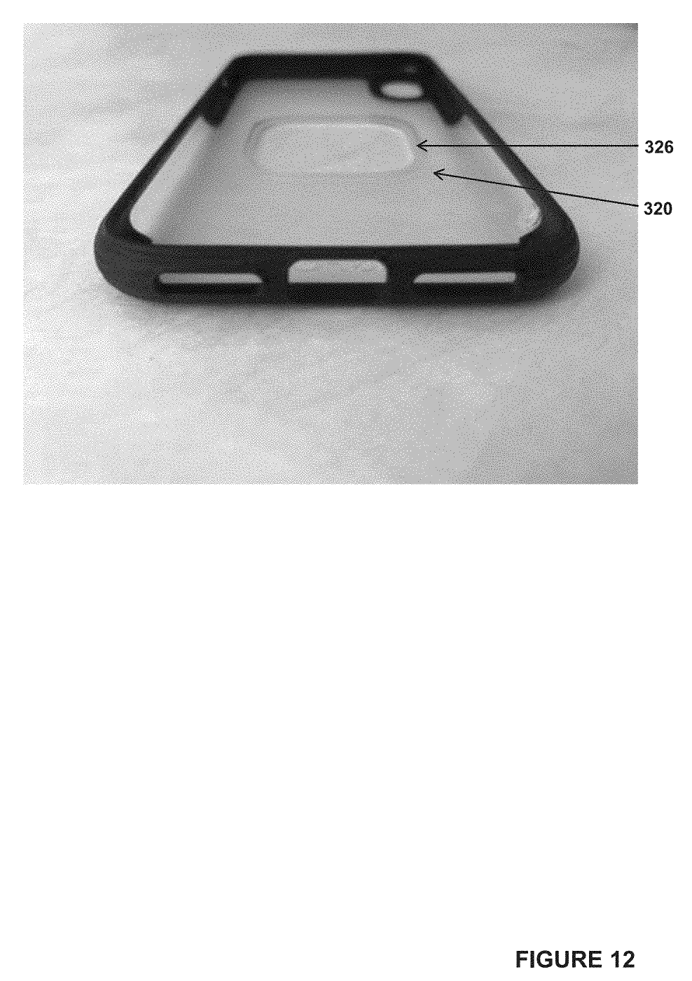

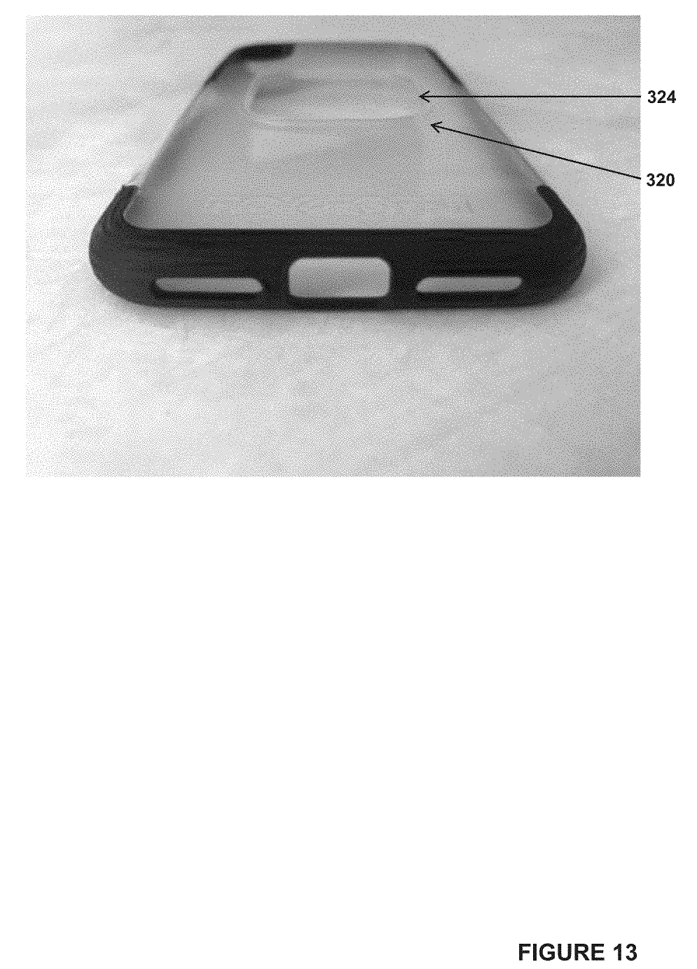

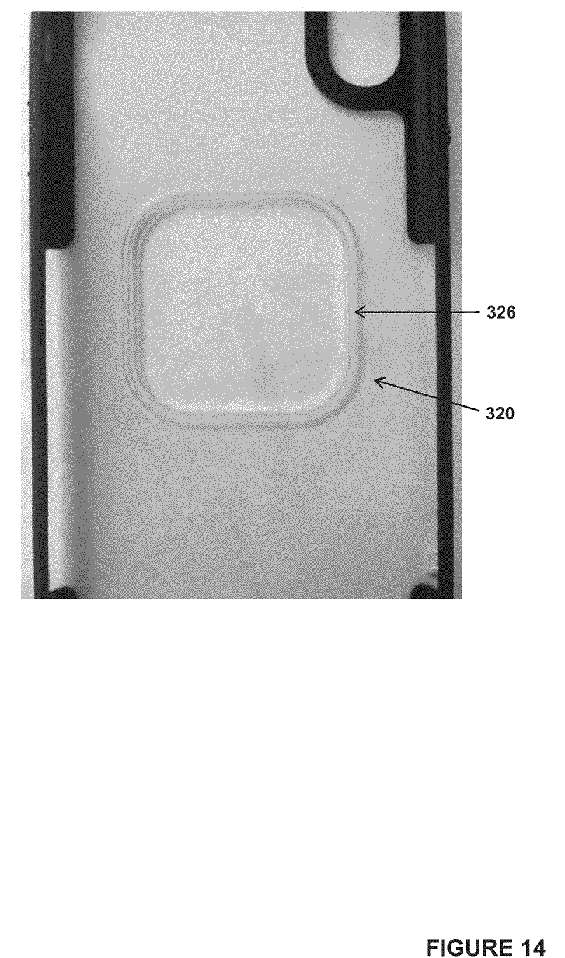

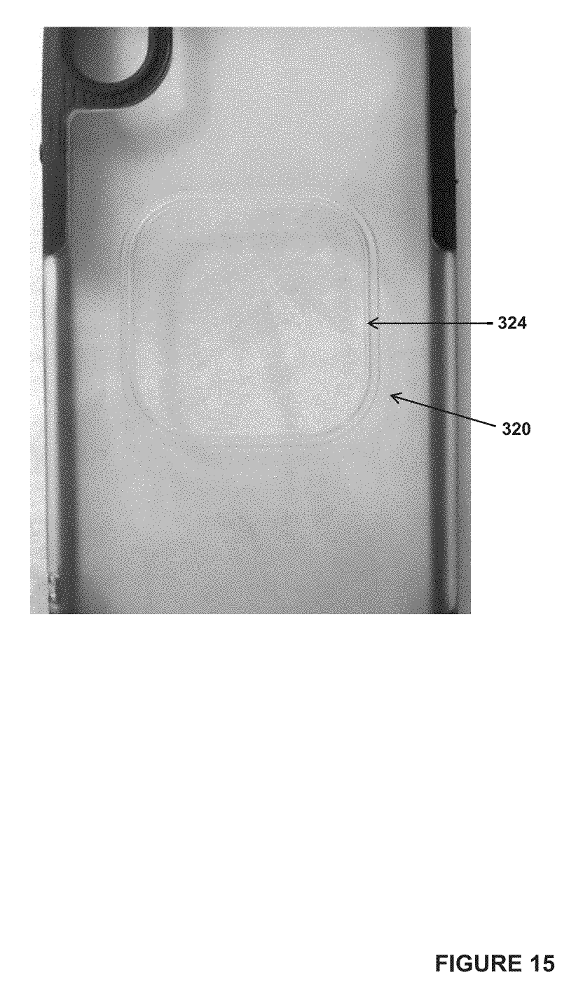

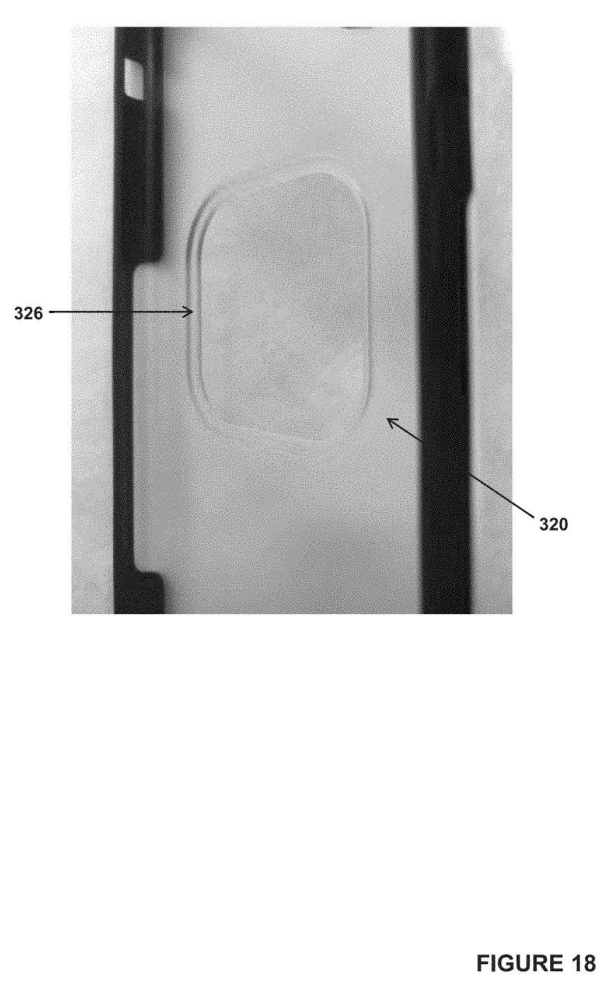

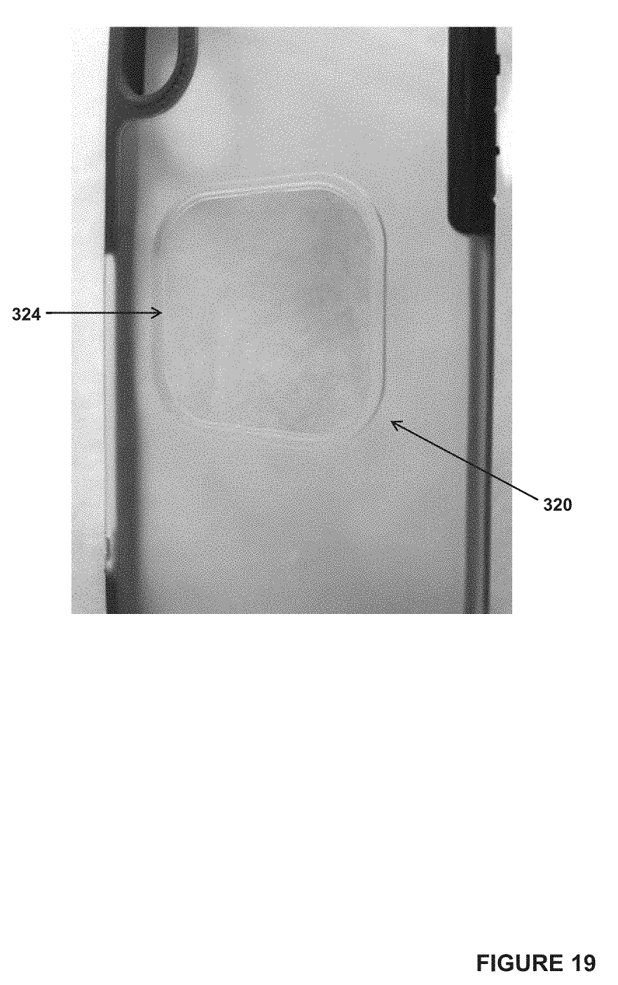

In a preferred embodiment shown for example in FIGS. 6, 7, 12-15, 18, and 19, the attachment region 320 comprises an opening configured to permanently or removably receive the insertable member 400. The shape of the insertable member 400 corresponds to the shape of the opening. A perimeter of the opening is configured to couple with the insertable member 400. When the insertable member 400 is received in or by the opening of the attachment region 320, the first ridge 410 of the insertable member 400 engages a portion of the perimeter of the opening defined by the outer surface 304 of the rear wall 302 and the second ridge 420 of the insertable member 400 engages a portion of the perimeter of the opening defined by the inner surface 306 of the rear wall 302. In this way, a portion of the perimeter of the opening is received within the groove 430 disposed between the first and second ridges 410, 420.

As shown in FIGS. 16, 17, and 23, the height and width dimensions of the first ridge 410 is less than the height and width dimensions of the second ridge 420, so as to facilitate insertion of the insertable member 400 into the opening of the attachment region 320 from the inner surface 306 side of the rear wall 302 of the shell. However, in other embodiments, the height and width dimensions of the second ridge 420 may be less than the height and width dimensions of the first ridge 410, so as to facilitate insertion of the insertable member 400 into the opening of the attachment region 320 from the outer surface 304 of the rear wall 302 of the shell.

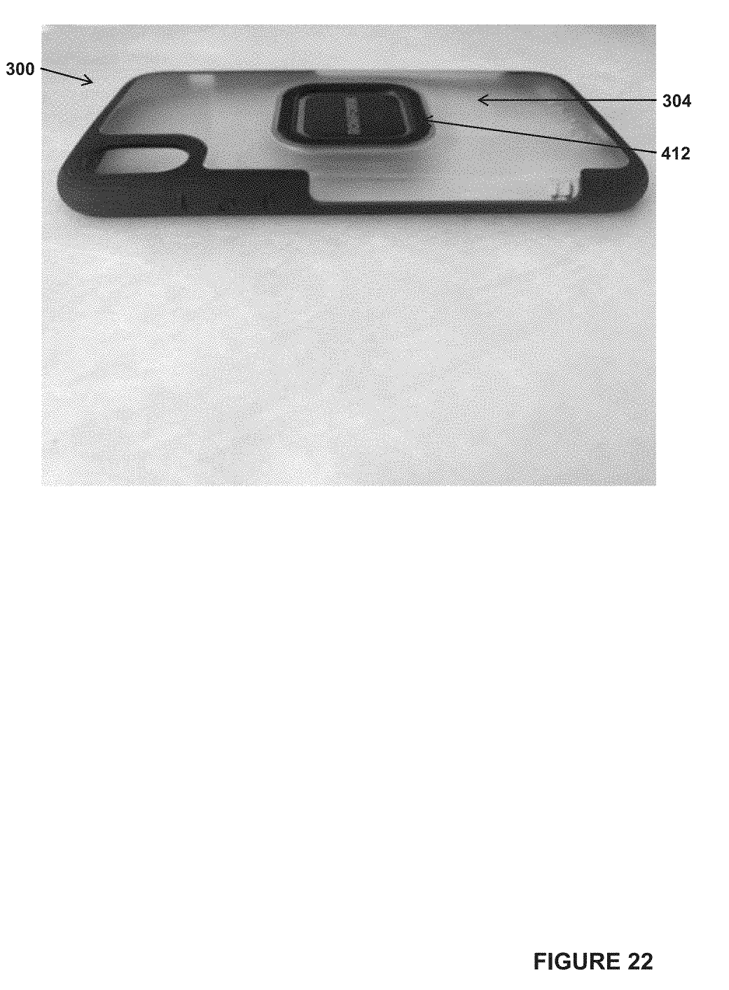

In a preferred embodiment shown for example in FIGS. 6, 7, 12-15, 18, and 19, the peripheral portion of the shell surrounding the opening defines an inner shoulder 326 on the inner surface 306 of the rear wall 302 and an outer shoulder 324 on the outer surface 304 of the rear wall 302. When the insertable member 400 is received in or by the opening of the attachment region 320, the first ridge 410 of the insertable member 400 engages the outer shoulder 324 and the second ridge 420 of the insertable member 400 engages the inner shoulder 326. In this way, the inner surface 422 of the insertable member 400 can be flush with the inner surface 306 of the rear wall 302 of the shell, as shown in FIG. 20, and the outer surface 412 of the insertable member 400 can be flush with the outer surface 304 of the rear wall 302 of the shell, as shown in FIGS. 21 and 22. However, in other embodiments, the outer surface 422 of the insertable member 400 can extend outwardly of at least a portion of the outer surface 304 of the rear wall 302 of the shell.

In some embodiments, the outer surface 412 of the insertable member 400 is textured and extends outwardly of at least a portion of the outer surface 304 of the rear wall 302 of the shell. The textured outer surface of the insertable member 400 can enhance frictional engagement of the shell with a surface on which the shell is placed.

FIG. 23 depicts an embodiment of the insertable member 400 and a magnetic mount 600 prior to engagement of the magnetic mount 600 with the insertable member 400. The magnetic mount 600 comprises an attachment region 602. In some embodiments, a surface (not shown) of the attachment region 602, which engages with the thin metal plate 500 of the insertable member 400, may be textured or have roughened or ridged surface features to help inhibit slippage of the mount 600 from or relative to the thin metal plate 500 and the insertable member 400. The attachment region 602 can be configured to have a lip or shoulder (not shown) that can engage with the shoulder 440 of the insertable member 400 to inhibit slippage of the insertable member 400 from or relative to the mount 600. An example of a lip or shoulder of a magnetic mount is shown in FIG. 5, which shows a lip or shoulder 206 that can engage with a corresponding shoulder.

Although the embodiment of the insertable member 400 and magnetic mount 600 is shown to have square or generally square shaped features, other shapes and embodiments are possible. For example, the features shown to be square or generally square in shape can be circular or generally circular in shape. As just one example, the square or generally square shape of the indentation on the outer surface 412 of the insertable member 400 which receives the thin metal plate 500 can be circular or generally circular in shape. In such a circular or generally circular embodiment, the insertable member 400 can engage with the circular shaped magnetic mount 200 shown in FIG. 5. Moreover, although FIG. 23 shows an embodiment of an insertable member 400 with a corresponding magnetic mount 600, the insertable member 400 can engage with a plurality of other magnetic mounts, such as the magnetic mount 200 shown in FIG. 5. Preferably, a plurality of insertable members is available and a plurality of magnetic mounts is available.

With reference still to FIG. 23, the magnetic mount 600 has a body region 608, which is configured to be attachable to an automobile air conditioner (or heater) vent (e.g., via a slot configured to receive a fin or louver of the vent). However, other types of body regions 608 can be provided depending on the desired use of the magnetic mount 600. For example, clip, adhesive or suction mount type body regions 608 can be provided.

When the magnetic mount 600 is engaged with the insertable member 400, the magnetic mount 600 is secured to the insertable member 400 via the horizontal forces (or forces perpendicular to the mounting surfaces or otherwise in the direction of magnetic attraction) provided by the magnetic attraction between the magnetic mount 600 and the thin metal plate 500. Vertical forces between the shoulder 440 of the insertable member 400 and the attachment region 602 of the magnetic mount 600 can also help secure the magnetic mount 600 to the insertable member 400 or at least help prevent rotation of the insertable member 400 relative to the mount 600.

Although this application discloses certain preferred embodiments and examples, it will be understood by those skilled in the art that the present inventions extend beyond the specifically disclosed embodiments to other alternative embodiments and/or uses of the invention and obvious modifications and equivalents thereof. Further, the various features of these inventions can be used alone, or in combination with other features of these inventions other than as expressly described above. While the disclosed embodiments are primarily directed to a protection system for a handheld electronic device, aspects of the invention may be used in connection with other types of protection systems. Thus, it is intended that the scope of the present inventions herein disclosed should not be limited by the particular disclosed embodiments described above, but should be determined only by a fair reading of the claims that follow.

What is claimed is:

1. A protection system for a handheld electronic device, comprising:
a shell comprising a rear wall and a side wall extending from the rear wall, wherein, in use, the side wall encloses a plurality of peripheral edges of an associated handheld electronic device;
wherein the rear wall defines an attachment region, the attachment region comprising a recess;
an elastomeric member positioned within the recess of the attachment region; and
a thin metal element carried by the elastomeric member, an outer surface of the thin metal element being recessed from an outer surface of the rear wall to define a shoulder, the shoulder configured to engage a magnetic mount to inhibit slippage of the shell relative to the mount.

2. The system of claim 1, further comprising the magnetic mount.

3. The system of claim 2, wherein a surface of the magnetic mount is textured to inhibit slippage of the shell relative to the mount, when in use.

4. The system of claim 2, wherein the magnetic mount comprises a lip that engages with the shoulder of the shell to inhibit slippage of the shell relative to the mount, when in use.

5. A protection system for a handheld electronic device, comprising:
a shell comprising a rear wall and a side wall extending from the rear wall, wherein, in use, the side wall encloses a plurality of peripheral edges of an associated handheld electronic device;
wherein the rear wall defines an attachment region comprising an opening, a periphery of the rear wall surrounding the opening defining an inner shoulder on an inner surface of the rear wall and an outer shoulder on an outer surface of the rear wall;
an insertable member received within the opening, wherein the insertable member has a perimeter which defines a first ridge, a second ridge, and a groove disposed between the first and second ridges, an outer surface of the insertable member having a thin metal element;
wherein, when the insertable member is received in the opening of the attachment region, the first ridge of the insertable member engages the outer shoulder and the second ridge of the insertable member engages the inner shoulder, such that a portion of the perimeter of the opening is received within the groove disposed between the first and second ridges to secure the insertable member to the shell;
wherein the thin metal element is recessed from the outer surface of the insertable member to define a shoulder, the shoulder configured to engage a magnetic mount to inhibit slippage of the shell relative to the mount.

6. The system of claim 5, further comprising the magnetic mount.

7. The system of claim 6, wherein a surface of the magnetic mount is textured to inhibit slippage of the shell relative to the mount, when in use.

8. The system of claim 6, wherein the magnetic mount comprises a lip that engages with the shoulder of the insertable member to inhibit slippage of the shell from the mount, when in use.

9. The system of claim 5, wherein the first ridge of the insertable member has a first height and width dimensions and the second ridge of the insertable member has a second height and width dimensions, the first height and width dimensions being less than the second height and width dimensions.

10. The system of claim 5, wherein an inner surface of the insertable member is flush with the inner surface of the rear wall of the shell.

11. The system of claim 5, wherein the outer surface of the insertable member is disposed outwardly of at least a portion of the outer surface of the rear wall of the shell.

12. The system of claim 5, wherein the outer surface of the insertable member is textured.

13. A protection system for a handheld electronic device, comprising:
a shell comprising a rear wall and a side wall extending from the rear wall, wherein, in use, the side wall encloses a plurality of peripheral edges of an associated handheld electronic device;
wherein the rear wall defines an attachment region comprising an opening;
an insertable member received within the opening; and
a thin metal element located on an outer surface of the insertable member, the thin metal element being recessed from the outer surface of the insertable member to define a shoulder, the shoulder configured to engage a magnetic mount to inhibit slippage of the shell relative to the mount.

14. The system of claim 13, further comprising the mount.

15. The system of claim 13, wherein the opening has a perimeter, the perimeter of the opening defined by an inner shoulder on an inner surface of the rear wall and an outer shoulder on an outer surface of the rear wall.

16. The system of claim 14, wherein the insertable member has a perimeter which defines a first ridge, a second ridge, and a groove disposed between the first and second ridges.
